(19) United States
(12) Patent Application Publication
(10) Pub. No.: US 2007/0052190 A1
(43) Pub. Date: Mar. 8, 2007

(54) Skateboard with flexible spine

(76) Inventor: Tobias D. Forsberg, Milwaukie, OR (US)

Correspondence Address: Keith A. Cushing, PO Box 19809, Portland, OR, 97280, US

(21) Appl. No.: 11/506,005

(22) Filed: Aug. 17, 2006

Related U.S. Application Data
(60) Provisional application No. 60/715,639, filed on Sep. 6, 2005.

(51) Int. Cl. B62M 1/00

(52) U.S. Cl. 280/87.042

(57) ABSTRACT

A resilient spine having an arched shape attaches to the under surface of a skateboard and carries truck assemblies at each end. The spine itself is biased away from the deck, but compressible in response to rider weight to conform to and against the undersurface of the skateboard deck. In use, the spine allows normal operation of the skateboard, but provides enhanced performance as the rider lifts or reduces weight applied to the skateboard deck thereby allowing the spine to uncompress and withdraw from the undersurface of the skateboard deck.

### RELATED PROVISIONAL APPLICATION

The present application derives priority from provisional application No. 60/715,639 filed Sep. 6, 2005, entitled Skateboard Flex-Spine, and naming Tobias David Forsberg as inventor therein.

### BACKGROUND

The sport of skateboarding has evolved significantly in recent years bringing forth an amazing array of tricks and stunts. A conventional skateboard includes a relatively rigid deck, typically having upturned tips, and a set of front and rear truck assemblies mounted to the undersurface of the deck. Each truck assembly carries a pair of roller-bearing mounted wheels. Typically, each wheel pair mounts to a common axel and the axel mounts in moveable relation to the deck to accommodate turning. More particularly, as the user applies greater weight laterally at the upper surface of the deck, the truck assembly through an intervening compressible bumper, moves the axel to direct the wheels in a compatible direction. Thus, for example, when the user leans to the left the truck assemblies respond by turning the front truck assembly and the rear truck assembly and the skateboard travels leftward. The structure and operation of such truck assemblies are well known and further discussion shall be omitted herein.

U.S. Pat. No. 4,123,080 issued Oct. 31, 1978 and entitled Skateboard discloses a skateboard having a platform or deck upon which the rider stands and a set of truck assemblies. Interposed between he deck and the truck assemblies is a suspension plate attached at its mid-length to a mid-length point at the undersurface of the deck and carrying the truck assemblies at each end. A pair of spacing elements interposed between the deck and the suspension element maintains the suspension element, itself normally biased toward the deck, away from the deck such that during use, i.e., with a rider's weight upon the upper surface of the deck the suspension element is intended to be separated from the undersurface of the skateboard deck. The suspension element is thereby maintained separated from the undersurface of the deck and acts as a shock-absorbing or suspension member.

U.S. Pat. No. 4,155,565 issued May 22, 1979 and entitled Adjustable Skateboard discloses a leaf spring structure mounted in spaced relation to the undersurface of a skateboard deck and carrying thereon a truck assembly. A selectively positionable element interposed between the leaf spring and the undersurface of the deck establishes a selected magnitude of resiliency for the leaf spring, i.e., by selectively adjusting a fulcrum or cantilever point for the leaf spring. The leaf spring is thereby necessarily maintained in spaced relation to the undersurface of the deck. Also, the structures suggested in this reference are likely to undesirably add excess weight to the overall skateboard and thereby undesirably affect performance.

In each of the above references a suspension element is by intent and design maintained in spaced relation to the undersurface of the skateboard deck to achieve the intended results. Unfortunately, such spacing only adds to the overall height of the skateboard and can affect performance thereof in relation to conventional-height skateboards. Thus, it is believed that these references do not teach of a skateboard spring lift or suspension enhancement capable of otherwise operating in the fashion of a conventional skateboard.

U.S. Pat. No. 6,145,857 issued Nov. 14, 2000 and entitled Skateboard Accessory discloses a resilient flat panel interposed between the truck assembly and the skateboard deck. The panel extends toward the end of the skateboard deck and, due the upturned curvature of the skateboard deck is separated from the undersurface of the skateboard deck at the tip thereof. As the rider drives the tip of the skateboard deck downward into the ground the panel bends and aids in thereafter driving upward the skateboard tip during an “Ollie” performance maneuver. In other words, the only way to load the panel away from its normally biased position is to place the skateboard deck at an extreme angle with a tip thereof pressed downward into the ground. Thus, while purportedly aiding in execution of an “Ollie” the proposed panel cannot provide any shock absorption or suspension enhancement when traveling over rough or undulating surface, e.g., when the skateboard deck is at a generally level orientation.

It would be desirable, therefore, to provide a skateboard spring lift and suspension enhancement, but otherwise allowing skateboard use generally in the fashion of a conventional skateboard.

### SUMMARY

A resilient spine having an arched shape attaches to the under surface of a skateboard and carries truck assemblies at each end. The spine is biased away from the deck, but compressible in response to rider weight to conform to and against the undersurface of the skateboard deck. In use, the spine allows normal operation of the skateboard, but provides enhanced performance as the rider lifts or reduces weight applied to the skateboard deck thereby allowing the spine to uncompress and withdraw from the undersurface of the skateboard deck.

The subject matter of embodiments of the present invention are particularly pointed out and distinctly claimed in the concluding portion of this specification. However, both the organization and method of operation of embodiments of the present invention, together with further advantages and objects thereof, may best be understood by reference to the following description taken with the accompanying drawings wherein like reference characters refer to like elements.

### BRIEF DESCRIPTION OF THE DRAWINGS

For a better understanding of embodiments of the present invention, and to show how the same may be carried into effect, reference will now be made, by way of example, to the accompanying drawings in which:

FIG. 1 illustrates in perspective a skateboard spine according to an embodiment of the present invention.

FIG. 2 illustrates in side view the skateboard spine of FIG. 1.

FIG. 3 illustrates in top view, and is representative of a bottom view, of the skateboard spine of FIGS. 1 and 2.

FIG. 4 illustrates by perspective wire frame view incorporation of the skateboard spine of FIGS. 1-3 into a conventional skateboard deck and truck assembly.

FIG. 5 illustrates the skateboard spine of FIG. 4 separated from the skateboard deck but attached to the skateboard truck assembly.

FIG. 6 illustrates the combined skateboard spine and conventional skateboard assemble in side view and in an uncompressed state.

FIG. 7 illustrates the combined skateboard spine and conventional skateboard assemble in side view and in a compressed state.

FIG. 8 illustrates the combined skateboard spine and conventional skateboard assemble in bottom view and in an uncompressed state.

FIG. 9 illustrates the combined skateboard spine and conventional skateboard assemble in end view and in an uncompressed state.

### DETAILED DESCRIPTION OF THE PREFERRED EMBODIMENT

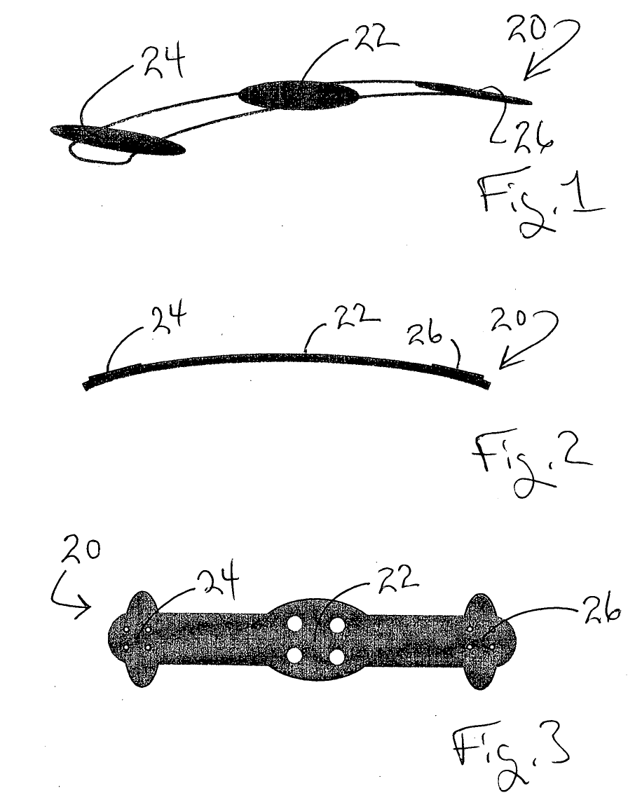

FIGS. 1-3 illustrate a spine 20 in perspective, side, and top views, respectively. As described more fully hereafter, spine 20 can be incorporated as an accessory to a conventional skateboard, e.g., added by the user or initially at the time of manufacture. Generally, spine 20 presents a flexible arched structure having an upward-facing deck attachment site 22 at its apex for attachment to the undersurface of a skateboard deck and having front and rear downward-facing truck assembly mounting sites 24 and 26 at each end thereof. Thus, for example, to incorporate spine 20 into an existing skateboard one removes the truck assemblies from the skateboard and mounts the truck assemblies at sites 24 and 26. Spine 20 thereby carries the truck assemblies. Spine 20 mounts to the under surface of the skateboard deck at site 22. In this manner, spine 20 serves as a structure intervening between the skateboard deck and the truck assemblies. In use, the weight of the rider compresses spine 20 against the undersurface of the skateboard deck and the overall assembly has the look, feel and substantially similar height of a conventional skateboard, but with enhanced shock absorption and lift assistance in executing performance tricks as described more fully hereafter.

Thus, according to a particular embodiment of the present invention, spine 20 can be approximately 22″ in length by 4″ in width and approximately ¼″ in thickness and naturally assume a concave or arched shape. It will be understood, however, that embodiments of the present invention may be implemented across a broad spectrum of dimensions and materials. Spine 20 can be constructed of a variety of materials and either integrated into a skateboard upon manufacture thereof, or added as an additional unit or accessory to an existing skateboard. Spine 20 can be a simple, single unit with no moving parts. Typically, spine 20 can be approximately the same length as, but possibly more narrow than, a traditional skateboard deck and mount lengthwise at the apex of its arch, e.g., at site 22, to the underside of an existing skateboard, e.g., by a set of bolts or other suitable mechanism attachable to the skateboard deck and generally at the apex of the arch of spine 20. Making the apex of the arch relatively wider at site 22 aids in mounting spine 20 to the skateboard deck. Also, the ends of spine 20 can be relatively wider, e.g., at sites 24 and 26 where standard skateboard truck assemblies mount. The natural arch of spine 20 causes the skateboard deck to rise, e.g., in a particular embodiment approximately 1.5″-3″ inches, higher than normal. However, upon application of a given magnitude of downward pressure upon the skateboard deck, e.g., a portion or all of the weight of an expected user, spine 20 compresses to a flat position along the undersurface of the skateboard deck. Thus, in use, e.g., with a rider standing on the skateboard deck, the overall assembly presents no significant difference in ride or appearance as compared to a traditional skateboard, e.g., as compared to one without addition of the intervening spine 20. However, when downward pressure is sufficiently reduced or released, e.g., as when jumping or going over bumps and undulating ground inconsistencies, the flexibility of spine 20 acts as a spring causing the skateboard to spring up with the rider, e.g., toward or reaching its un-mounted or naturally arched position. Thus, spine 20 acts as a shock absorber for the rider as well as a lift enhancement enabling the rider to get higher jumps and enhanced freestyle tricks.

Mounting site 22 can be wider (approximately 4″ to 5″ in width) for strength and to allow the spine to be held closely and securely to the skateboard and thereby minimize shifting upon turning and when under pressure in use. The wider ends of spine 20, directly above the intended truck and wheel location, are relatively wider and aid in preventing a natural urge of the skateboard to rock off spine 20 when tilting, turning or putting pressure on either side of the skateboard. Thus, according to some embodiments of the present invention, the two ends of spine 20 can be nearly as wide as the skateboard deck and when in use are compressed against the undersurface of the skateboard deck thereby allowing the overall assembly to be as responsive to the rider's needs as a conventional skateboard, as responsive as a skateboard with the truck assemblies attached directly to the undersurface of the skateboard deck.

The arch of spine 20 is established in the manufacturing process and has a memory allowing it to flex back to its original or arched position after pressure is released, preferably numerous times for durability and to allow extended use. The pressure necessary to compress the board down to a flat position will vary, depending upon the design of a particular embodiment and the intended rider's weight. Skateboarders interested in maximizing height in tricks, jumping curbs, reducing stress upon impact (i.e. shock absorption), and assisting the board to stay closer to the rider's feet when airborne, will find spine 20, as an accessory to or integral component of a skateboard, most useful and beneficial.

As will be appreciated, the weight of an intended rider may vary. Embodiments of the present invention may be formed according to the weight of an intended rider. As such, many forms of the present invention may be manufactured across a broad spectrum of resilience in spine 20. Accordingly, the present invention shall not be limited to a particular weight of intended rider, it being understood that spine 20 is intended to compress fully or “bottom out” in response to an intended rider's weight. In particular, to fully compress spine 20 against the undersurface of the skateboard deck 42, it should conform to and against the deck 42 in response to less than the rider's weight. In some cases, such can occur in response to a percentage of the rider's weight, e.g., need not require the full weight of the rider to compress spine 20 into its compressed position against and along the undersurface of deck 42. For example, spine 20 can compress in response to 75 pounds pressure against the upper surface of deck 42 thereby fully compressing or “bottoming out” in response to a broad spectrum of rider weights, but still storing a significant amount of potential energy for performance enhancements.

FIG. 4 illustrates, in perspective wire-frame view, use of spine 20 as attached to a conventional skateboard 40. Skateboard 40 includes a deck 42, a first truck assembly 44, and a second truck assembly 44. Deck 42 includes tipped, e.g., angled upward, tails at each end according to conventional deck design. Truck assemblies 44 and 46 include conventional features such as bearing-mounted wheels and axel turning features as are common to well known truck assemblies. Accordingly, the details of truck assemblies 44 and 46 will not be further discussed or detailed in the drawings, it being understood that truck assemblies 44 and 46 can be of generally conventional design and operation.

FIG. 5 illustrates spine 20 separately, but with truck assemblies 44 and 46 mounted thereto. Thus, FIG. 5 represents and intermediate step in a method of incorporating spine 20 into conventional skateboard 40. More particularly, once the truck assemblies 44 and 46 are dismounted from deck 42 of skateboard 40, truck assemblies 44 and 46 attach to spine 20 at mounting sites 24 and 26, respectively. Truck assemblies generally follow a conventional mounting arrangement, e.g., a set of four bolt-and-nut pairs with corresponding hole patterns in the deck 42 and truck assemblies 44 and 46. Accordingly, mounting sites 24 and 26 follow such convention allowing truck assemblies 44 and 46 to easily attach to spine 20. Deck 42 may be modified to allow attachment of spine 20 according to the selected mounting arrangement at site 22. For example, mounting site 22 includes a set of holes through spine 20 and deck 42 may be modified to include a corresponding hole-pattern. In other words, drilling holes according to the hole-pattern of mounting site 22 modifies deck 42 to receive spine 20. Spine 20 thereby mounts to deck 42 with a set of bolt-and-nut pairs for each hole in the hole-pattern. It will be understood, however, the present invention shall not be limited to any particular mounting scheme.

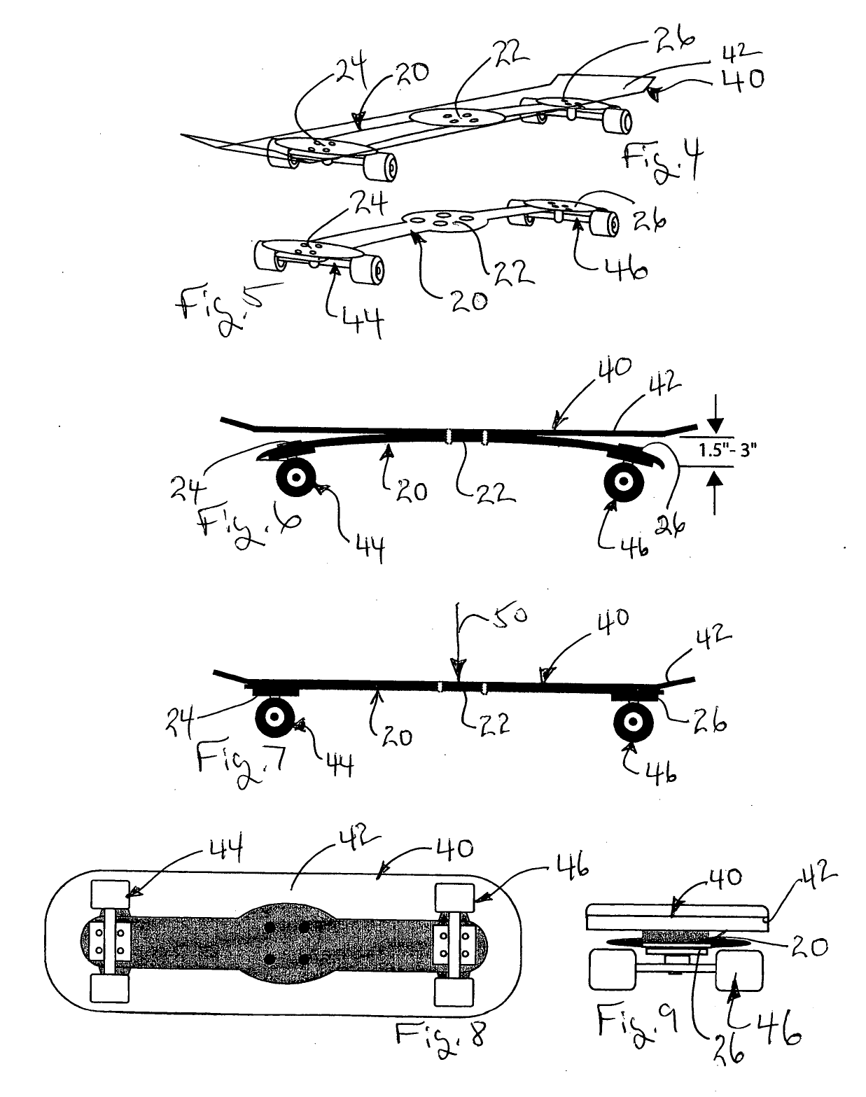

As best seen in FIG. 6, with spine 20 attached to deck 42, truck assemblies 44 and 46 resting on a ground surface (not shown) and no weight resting on deck 42, spine 20 assumes its arched or uncompressed state. In such state, deck 42 rises slightly, in this particular embodiment approximately 1.5″ to 3″, above its height with spine 20 attached thereto. In FIG. 7, however, a downward force 50 represents at least a portion of the weight of an intended rider upon the upward-facing surface of deck 42. Under such force 50, spine 20 compresses or flattens against the downward-facing surface of deck 42. In such state, skateboard 40 with spine 20 attached as described assumes a generally conventional configuration, e.g., approximately the same height and operability as skateboard 40 but without spine 20 attached thereto.

A rider can thereby operate skateboard 40 substantially in conventional fashion so long as the magnitude of force 50 is sufficient to keep spine 20 in its compressed state, e.g., as illustrated in FIG. 7. Thus, a variety of skateboard maneuvers can be performed with the magnitude of force 50 at sufficient level to keep as spine 20 flat against the downward-facing surface of deck 42. By variation in the magnitude of force 50, e.g., reduction or elimination of force 50, the rider enjoys enhanced skateboard performance. For example, travel surface variation allows spine 20 to act as a shock-absorbing member to smooth the ride over an undesirably rough or undulating travel surface, e.g., when skateboard deck 42 is in a generally level orientation. Many performance tricks include a rider slapping the tail of deck 42 onto a travel surface, e.g., an “Ollie” maneuver, in essence bouncing the skateboard off the ground. In such maneuver, the rider drives a tail of skateboard deck 42 against the ground and achieving the normal engagement thereagainst, but as the rider continues by reducing the force applied to the upper surface of the skateboard deck, spine 20 at the lower end of skateboard deck 42 is allowed to uncompress and aid in lifting the entire assembly. As a result, spine 20 provides a lift enhancement. In many cases the rider will substantially reduce or eliminate the magnitude of force 50 during such maneuvers. Accordingly, spine 20 operates to enhance the bounce achieved during such performance tricks. A similar performance advantage occurs when a rider simply jumps from the deck 42, e.g., the spring effect provided by spine 20 enhances the performance. While these are but a limited number of examples, experienced skateboard enthusiasts will no doubt exploit the spring effect provided by spine 20 in many ways.

While a variety of materials maybe used to implement embodiments of the present invention, durable, molded carbon fiber provides a lightweight skateboard accessory that enhances performance and reduces impact during use.

Embodiments of the present invention utilize suspension, compression and stored energy for an enhanced skateboard experience. Prior suspension based skateboards and accessories have low acceptance because of a significant reduction in performance through added weight and height. Embodiments of the present invention, however, provide a single, elongated and concave piece of, for example, molded carbon fiber enhancing performance without sacrificing weight and height.

Generally, spine 20 attaches to the center of the skateboard deck with the truck assemblies mounted at each end of spine 20. Upon receiving the rider's weight, spine 20, being a concave molded structure, compresses to a flat position against the undersurface of the skateboard deck. The flat compression and elongated ends of spine 20 allow the skateboard to proficiently carve and perform. However, when the rider's weight is lifted or reduced from the skateboard deck, as when executing jumps, tricks and upon taking air, spine 20 springs into life with dynamic performance enhancing capabilities. Spine 20 also significantly reduces impact upon landing due to its natural arched shape. In normal riding mode, in a particular embodiment of the present invention, over 75 lbs of harnessed pressure is available for release.

Incorporating spine 20 into a conventional skateboard can increase trick height and performance by nearly 20 percent, yet can weigh as little as 1 pound depending upon the thickness of the carbon fiber used in manufacture thereof. Other materials can be utilized, however few combine the high resistance-to-weight ratio of carbon fiber.

In addition to performance enhancing characteristics, embodiments of the present invention do not impair or diverge from the common skateboard, allowing riders to easily upgrade existing boards without vast alterations, weight gain or performance loss. Also, embodiments of the present invention can be manufactured easily and cost effectively. Embodiments of the present invention can sold to the end-user as a stand-alone accessory or integrated into a fully assembled skateboard. Embodiments of the present invention don't require other items or special tools and advantageously utilize existing skateboard components, allowing boarders to continue to customize their skateboards.

It will be appreciated that the present invention is not restricted to the particular embodiments that have been described and illustrated, and that variations may be made therein without departing from the scope of the invention as found in the appended claims and equivalents thereof.

What is claimed is:

1. A flexible spine attachable to a skateboard deck and to truck assemblies:
an arched flexible spine having a deck mounting site and having first and second truck mounting sites, the spine being compressible to conform to and against an undersurface of a deck when mounted thereto in response to a given magnitude of pressure applied to a upper surface thereof.

2. The flexible spine according to claim 1 wherein the deck mounting site is located substantially at an apex of the arch of the arched shape of the spine.

3. The flexible spine according to claim 1 wherein the first and second truck mounting sites are located at first and second ends, respectively, of the spine.

4. The flexible spine according to claim 1 wherein the given magnitude of pressure is less than the weight of an expected skateboard rider.

5. The flexible spine according to claim 1 wherein the given magnitude of pressure is approximately 75 pounds.

6. The flexible spine according to claim 1 wherein the spine comprises a carbon fiber material.

7. A method of modifying a skateboard having first and second truck assemblies mounted to a deck, the method comprising:
dismounting from the deck the first and second truck assemblies;
attaching the first and second truck assemblies to first and second truck mounting sites of a flexible spine, the first and second truck mounting sites being located at first and second ends, respectively, of the flexible spine; and
attaching the deck to a deck mounting site of the flexible spine, the spine being compressible to conform to and against the undersurface of the deck in response to a given magnitude of pressure applied to an upper surface of the deck.

8. The method according to claim 7 wherein the deck mounting site is located substantially at an apex of the arch of the arched shape of the spine.

9. The method according to claim 7 wherein the first and second truck mounting sites are located at first and second ends, respectively, of the spine.

10. The method according to claim 7 wherein the given magnitude of pressure is less than the weight of an expected skateboard rider.

11. The method according to claim 7 wherein the given magnitude of pressure is less than 75 pounds.

12. The method according to claim 7 wherein the spine comprises a carbon fiber material.

13. A skateboard comprising:
a generally planar deck having a mid portion, an upper surface, and a lower surface;
a first truck assembly;
a second truck assembly; and
a resilient spine having an arched shape defining an apex, a first end, a second end, a deck mounting site at the apex to attach the mid portion of the deck thereto, a first truck mounting site at the first end to attach the first truck assembly thereto, and a second truck mounting site at the second end to attach the second truck assembly thereto, the spine when attached to the deck being biased away from the deck and compressible to conform to and against the undersurface of the deck in response to a given magnitude of pressure applied to the upper surface of the deck.

14. The skateboard according to claim 13 wherein the given magnitude of pressure is less than the weight of an expected skateboard rider.

15. The skateboard according to claim 13 wherein the spine comprises a carbon fiber material.

16. The skateboard according to claim 13 wherein the given magnitude of pressure is approximately 75 pounds.
